(19) United States
(12) Patent Application Publication
(10) Pub. No.: US 2012/0054485 A1
(43) Pub. Date: Mar. 1, 2012

(54) TERMINAL DEVICE, SERVER, DATA PROCESSING SYSTEM, DATA PROCESSING METHOD, AND PROGRAM

(75) Inventors: Yu TANAKA, Tokyo (JP); Tomoyuki Asano, Kanagawa (JP); Masakazu Ukita, Kanagawa (JP); Masanobu Katagi, Kanagawa (JP); Yohei Kawamoto, Tokyo (JP); Seiichi Matsuda, Tokyo (JP); Shiho Moriai, Kanagawa (JP)

(73) Assignee: Sony Corporation, Tokyo (JP)

(21) Appl. No.: 13/204,223

(22) Filed: Aug. 5, 2011

(30) Foreign Application Priority Data
Aug. 25, 2010 (JP) 2010-188128

(51) Int. Cl. H04L 9/00

(52) U.S. Cl. 713/150

(57) ABSTRACT

Disclosed is a terminal device, which includes an encrypting section encrypting input data in a fully homomorphic encryption scheme to generate encrypted data; an encrypted data transmission section transmitting the encrypted data generated by the encrypting section to a server; an encrypted data reception section receiving the encrypted data on which the server implements a predetermined process; and a decrypting section decrypting the encrypted data on which the predetermined process is implemented.

### BACKGROUND

The present disclosure relates to a terminal device, a server, a data processing system, a data processing method, and a program.

In recent years, there has been increasing demand for monitoring camera systems for security reasons. The monitoring camera system includes mainly a monitoring camera for capturing a monitoring target and a monitoring server for analyzing video data which is captured by the monitoring camera. An observer checks the video data captured by the monitoring camera through a display connected to the monitoring server. In addition, as the analysis result of the video data, when there is an abnormality in the monitoring target, the monitoring server issues an alarm or explicitly shows the observer abnormality portions in the video data. Recently, the analysis technology of the video data has been advanced, so that the observer can effectively detect the abnormality of the monitoring target with high probability.

On the other hand, since the observer may check the video data even when there is no abnormality in the monitoring target, there is concern of an invasion of privacy. In order to remove such concerns, a mechanism in which the observer is not able to see the portions having no abnormality of the monitoring target in the video data is being considered. For example, in the following Japanese Unexamined Patent Application Publication No. 2005-269489, a masking technology is disclosed in which the portions having no abnormality of the monitoring target are masked in the video data. According to the technology, an abnormality detection mechanism and a masking mechanism are installed in the monitoring camera, so that the monitoring camera generates the video data in which the portions having no abnormality are masked, and transmits it to the monitoring server. Using the technology, the observer is not able to see the portions in which abnormality is not detected, so that an invasion of privacy can be avoided.

### SUMMARY

In the technology described in Japanese Unexamined Patent Application Publication No. 2005-269489, installing the abnormality determination mechanism in the monitoring camera is the premise. However, in the case that the abnormality determination mechanism is installed in the monitoring camera, when the monitoring camera is reverse-engineered, there may be a risk of an abnormality detection logic of the abnormality detection mechanism being exposed. For this reason, on the premise that the abnormality detection mechanism is installed in the monitoring server, a mechanism for transmitting only the video data in which there is an abnormality to the monitoring server is sought. In other words, the mechanism, in which the abnormality detection of the video data is implemented by the monitoring server without letting the monitoring server know the contents of the video data, is sought.

In addition, though different from the monitoring camera system, in a server-client system in which data is processed by the server, the same mechanism is requested even when the data input from a client terminal is processed by the server without letting the server know the contents of the data. For example, in a retrieval system, it may be considered that a retrieval process is implemented by the retrieval server without letting the retrieval server know the retrieval keyword input from the client terminal. In addition, in a cloud system, it may be considered that a predetermined process is implemented by the cloud server without letting the cloud server know the input data from the client terminal.

The present disclosure has been made to address the above-mentioned problems, and it is desirable to provide: a novel and improved data processing system, which can make the server implement a process against the input data without letting the server know the contents of the processing input data; a terminal device and the server which are included in the data processing system; a data processing method used in the data processing system; and a program.

In order to solve the above-mentioned problems, according to an embodiment of the disclosure, there is provided a terminal device including: an encrypting section encrypting input data in a fully homomorphic encryption scheme to generate encrypted data; an encrypted data transmission section transmitting the encrypted data generated by the encrypting section to a server; an encrypted data reception section receiving the encrypted data on which the server implements a predetermined process; and a decrypting section decrypting the encrypted data on which the predetermined process is implemented.

In addition, the terminal device may further include an imaging section capturing a subject to generate image data. In this case, the encrypting section encrypts the image data generated by the imaging section to generate encrypted data, and the predetermined process is a process in which the encrypted data is input to an abnormality determination algorithm for determining an abnormality in the subject based on the image data and a determination result output from the abnormality determination algorithm is output as encrypted data on which the predetermined process is implemented.

In addition, the terminal device may further include: an abnormality determination section determining whether there is an abnormality in the determination result after the encrypted data on which the decrypting section implements the predetermined process is decrypted and the determination result is output from the abnormality determination algorithm; and an image data transmission section transmitting the image data generated by the imaging section to the server when there is an abnormality in the determination result of the abnormality determination section.

In addition, the terminal device may further include a key holding section holding a public key and a secret key based on the fully homomorphic encryption scheme. In this case, the encrypting section encrypts input data using the public key which is held by the key holding section; and the decrypting section decrypts the encrypted data on which the predetermined process is implemented, using the secret key which is held by the key holding section.

In addition, the predetermined process may be implemented using the public key.

In addition, the terminal device may further include an input section inputting retrieval data, and a display section displaying a retrieval result based on the retrieval data. In this case, the encrypting section encrypts the retrieval data, which is input by the input section, to generate encrypted data; the predetermined process is a process in which the encrypted data is input to a retrieval algorithm for retrieving information based on the retrieval data and outputs the retrieval result output from the retrieval algorithm as the encrypted data on which the predetermined process is implemented; and after the encrypted data on which the predetermined process is implemented is decrypted by the decrypting section and the retrieval result output from the retrieval algorithm is obtained, the display section displays the retrieval algorithm.

According to an embodiment of the disclosure, to solve the above-mentioned problems, there is provided a server including: an encrypted data reception section receiving encrypted data from a terminal device, the encrypted data being obtained by encrypting input data in a fully homomorphic encryption scheme; a process section implementing a predetermined process on the encrypted data; and an encrypted data transmission section transmitting the encrypted data to the terminal device, the predetermined process being implemented on the encrypted data.

According to still another embodiment of the disclosure, to solve the above-mentioned problems, there is provided a data processing system including: a terminal device which includes an encrypting section encrypting input data in a fully homomorphic encryption scheme to generate encrypted data, a first transmission section transmitting the encrypted data to a server, the encrypted data being generated by the encrypting section, a first reception section receiving the encrypted data on which the server implements a predetermined process, and a decrypting section decrypting the encrypted data on which the predetermined process is implemented; and a server which includes a second reception section receiving the encrypted data transmitted from the first transmission section, a process section implementing the predetermined process on the encrypted data, and a second transmission section transmitting the encrypted data to the terminal device, the predetermined process being implemented on the encrypted data.

According to still another embodiment of the disclosure, to solve the above-mentioned problems, there is provided a data processing method including: causing a terminal device to encrypt input data in a fully homomorphic encryption scheme to generate encrypted data, and to transmit the encrypted data to a server, the encrypted data being generated in the encrypting of the input data; causing the server to receive the encrypted data which is transmitted in the transmitting of the encrypted data to the server, to implement a predetermined process on the encrypted data, and to transmit the encrypted data to the terminal device, the predetermined process being implemented on the encrypted data; and causing the terminal device to receive the encrypted data on which the server implements the predetermined process, and to decrypt the encrypted data on which the predetermined process is implemented.

According to still another embodiment of the disclosure, to solve the above-mentioned problems, there is provided a program causing a computer to execute: an encrypting function of encrypting input data in a fully homomorphic encryption scheme to generate encrypted data; an encrypted data transmission function of transmitting the encrypted data generated by the encrypting function to a server; an encrypted data reception function of receiving the encrypted data on which the server implements a predetermined process; and a decrypting function of decrypting the encrypted data on which the predetermined process is implemented.

According to still another embodiment of the disclosure, to solve the above-mentioned problems, there is provided a program causing a computer to execute: an encrypted data reception function of receiving encrypted data from a terminal device, the encrypted data being obtained by encrypting input data in a fully homomorphic encryption scheme; a process function of implementing a predetermined process on the encrypted data; and an encrypted data transmission function of transmitting the encrypted data to the terminal device, the predetermined process being implemented on the encrypted data.

In addition, according to still another embodiment of the disclosure, to solve the above-mentioned problems, there is provided a computer readable recording medium in which the program is recorded.

According to the present disclosure as described above, the processing of the input data can be performed by the server, without revealing the contents of the input data to be processed.

### BRIEF DESCRIPTION OF THE DRAWINGS

FIG. 1 is an explanatory diagram illustrating the system configuration of a monitoring camera system according to a first embodiment of the present disclosure;

FIG. 2 is an explanatory diagram illustrating the functional configuration of a monitoring camera according to the first embodiment;

FIG. 3 is an explanatory diagram illustrating the functional configuration of a monitoring server according to the first embodiment;

FIG. 4 is an explanatory diagram illustrating the functional configuration of an image analysis section according to the first embodiment;

FIG. 5 is an explanatory diagram illustrating the functional configuration of an abnormality determination algorithm generation section according to the first embodiment;

FIG. 6 is an explanatory diagram illustrating the characteristics of a fully homomorphic encryption;

FIG. 7 is an explanatory diagram illustrating an abnormality determination processing flow of the monitoring camera system according to the first embodiment;

FIG. 8 is an explanatory diagram illustrating the system configuration of a data processing system according to a second embodiment of the present disclosure;

FIG. 9 is an explanatory diagram illustrating the functional configuration of a user terminal according to the second embodiment;

FIG. 10 is an explanatory diagram illustrating the functional configuration of a data processing server according to the second embodiment;

FIG. 11 is an explanatory diagram illustrating a data processing flow of the data processing system according to the second embodiment;

FIG. 12 is an explanatory diagram illustrating the system configuration of a retrieval system according to a third embodiment of the present disclosure;

FIG. 13 is an explanatory diagram illustrating the functional configuration of the retrieval server according to the third embodiment;

FIG. 14 is an explanatory diagram illustrating the flow of a retrieval process of the retrieval system according to the third embodiment; and

FIG. 15 is an explanatory diagram illustrating the hardware configuration for implementing functions of the monitoring camera, the monitoring server, the user terminal, the data processing server, and the retrieval server according to the embodiments of the present disclosure.

### DETAILED DESCRIPTION OF EMBODIMENTS

Hereinafter, preferred embodiments of the present disclosure will be described in detail with reference to the accompanying drawings. Further, in the present specification and the drawings, the components having substantially the same functional configurations are designated by the same reference numerals, and the description already given will be omitted.

Description Flow

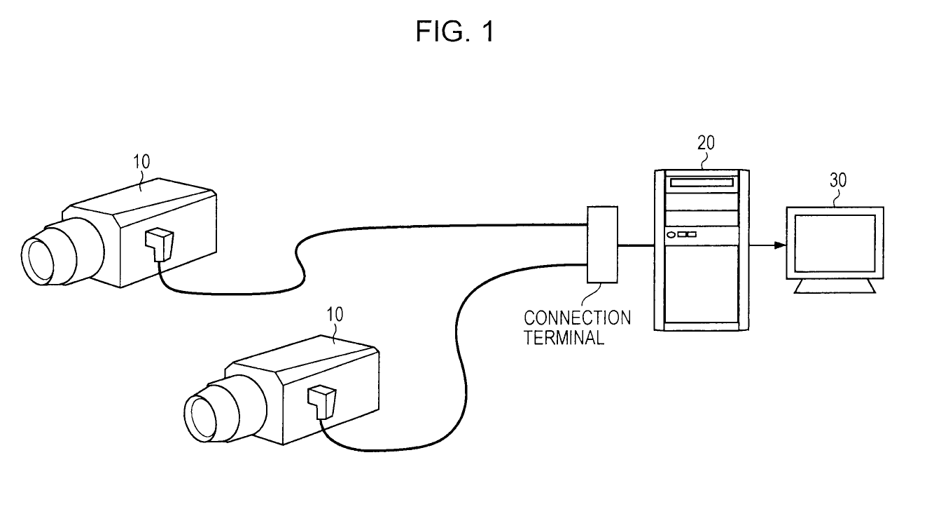

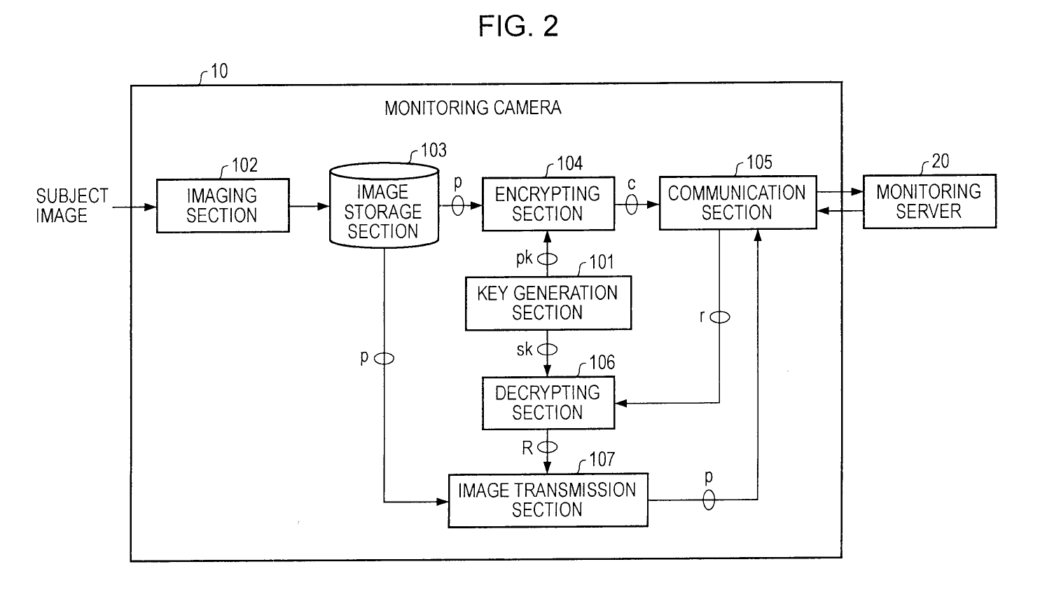

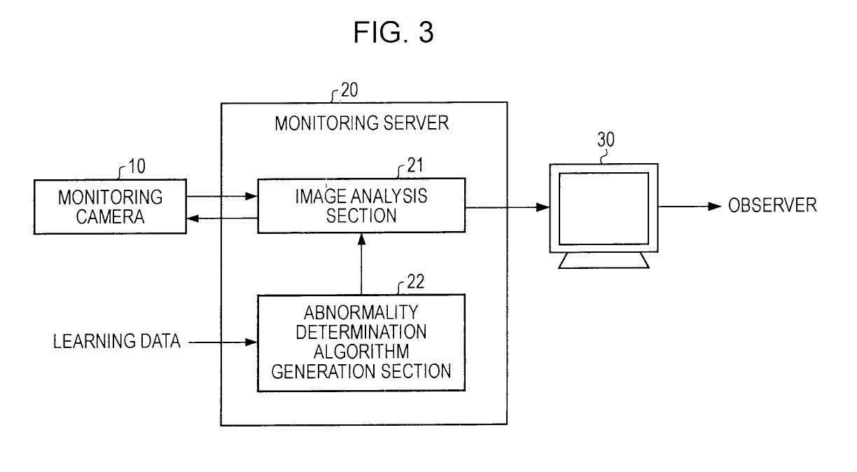

Here, the flow of descriptions of the embodiments of the disclosure will be briefly stated below. First, referring to FIG. 1, a system configuration of a monitoring camera system according to a first embodiment of the present disclosure will be described. Next, referring to FIG. 2, a functional configuration of a monitoring camera 10 according to the first embodiment will be described. Next, referring to FIG. 3, a functional configuration of a monitoring server 20 according to the first embodiment will be described.

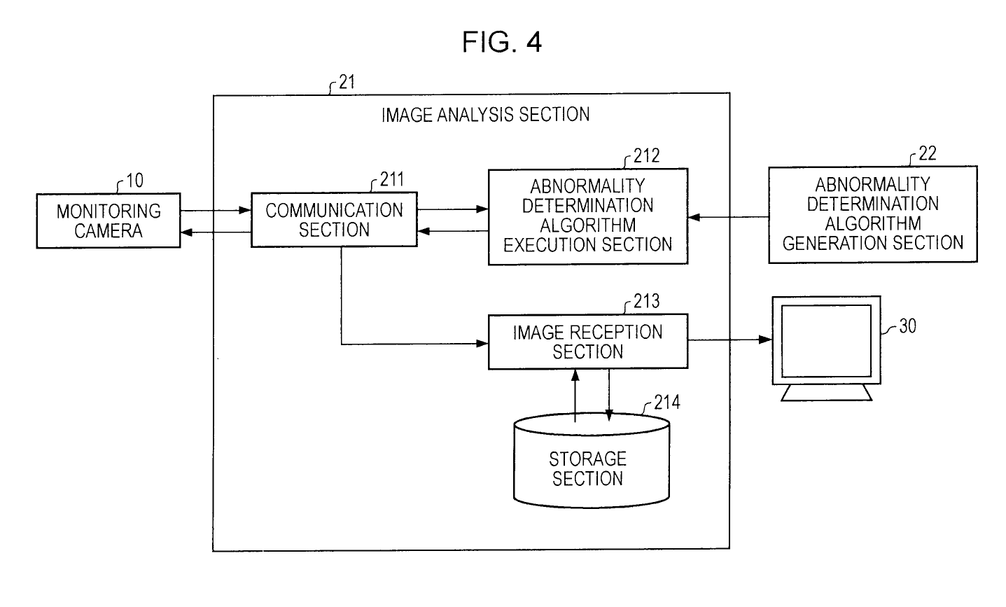

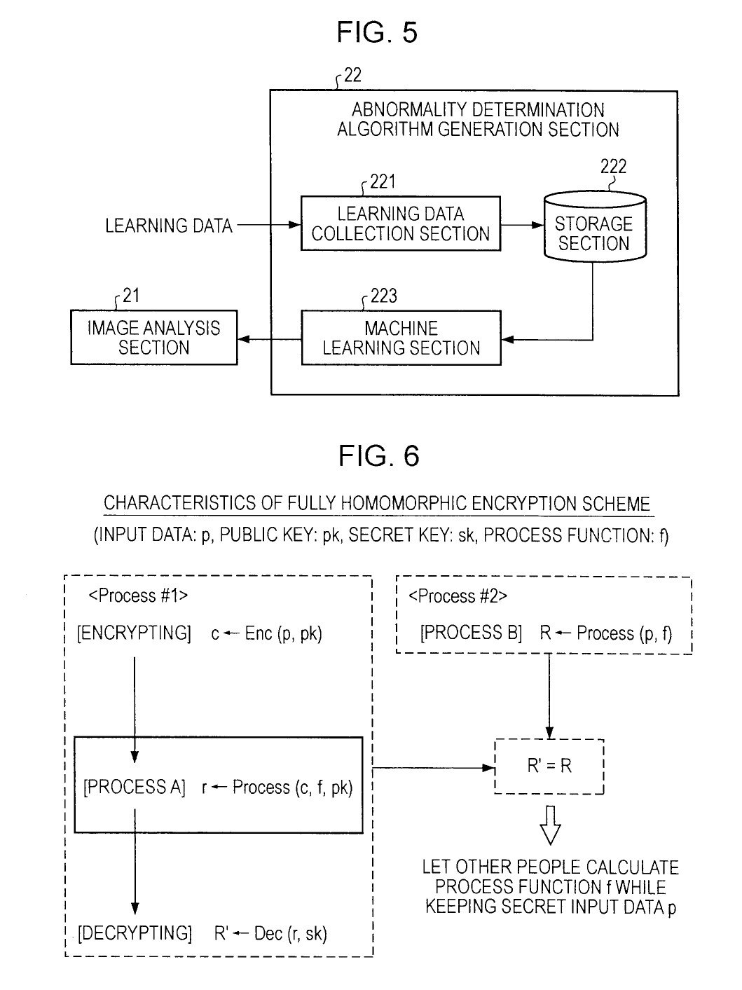

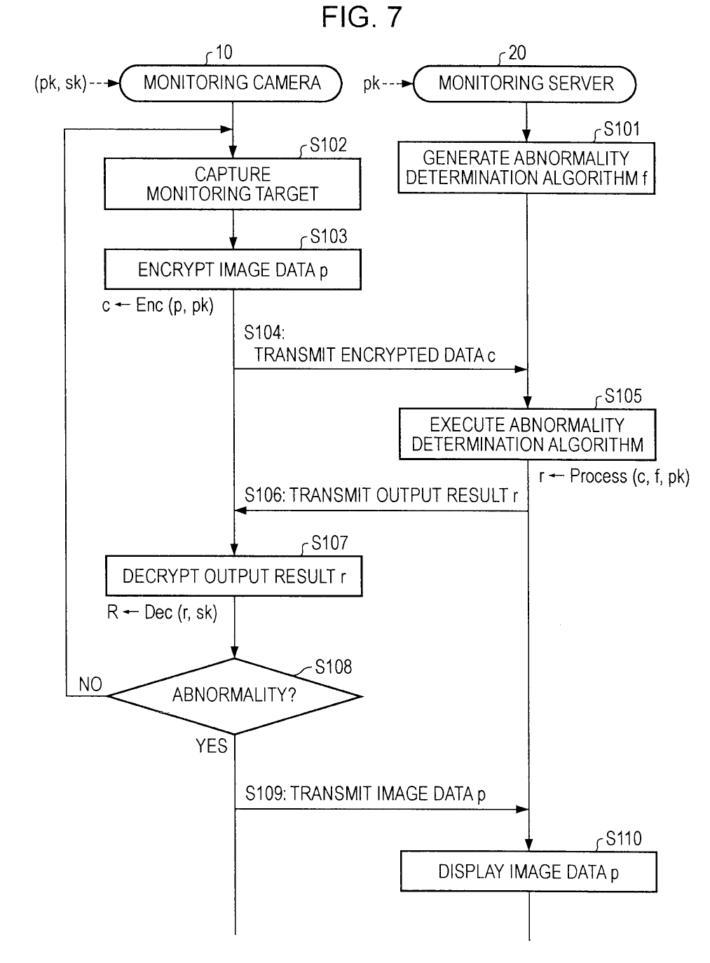

Then, referring to FIG. 4, a functional configuration of an image analysis section 21 according to the first embodiment will be described. Next, referring to FIG. 5, a functional configuration of an abnormality determination algorithm generation section 22 according to the first embodiment will be described. Next, referring to FIG. 7, the flow of an abnormality determination process in the monitoring camera system according to the first embodiment will be described. Further, referring to FIG. 6, the characteristics of a fully homomorphic encryption in the above description will be described.

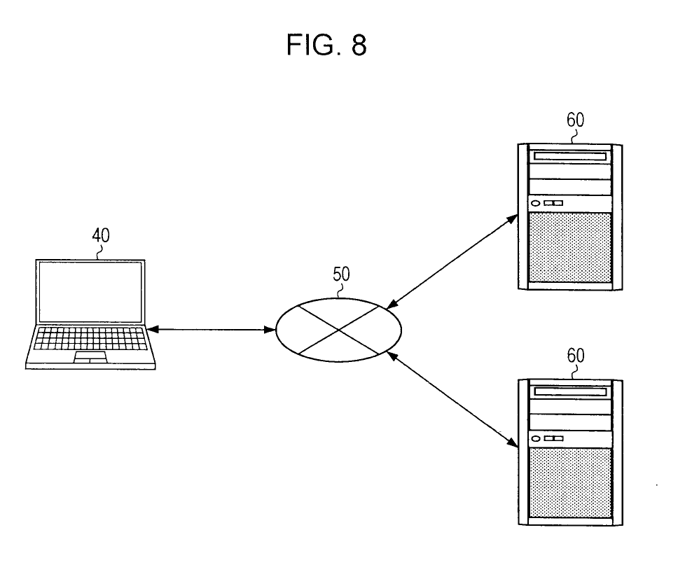

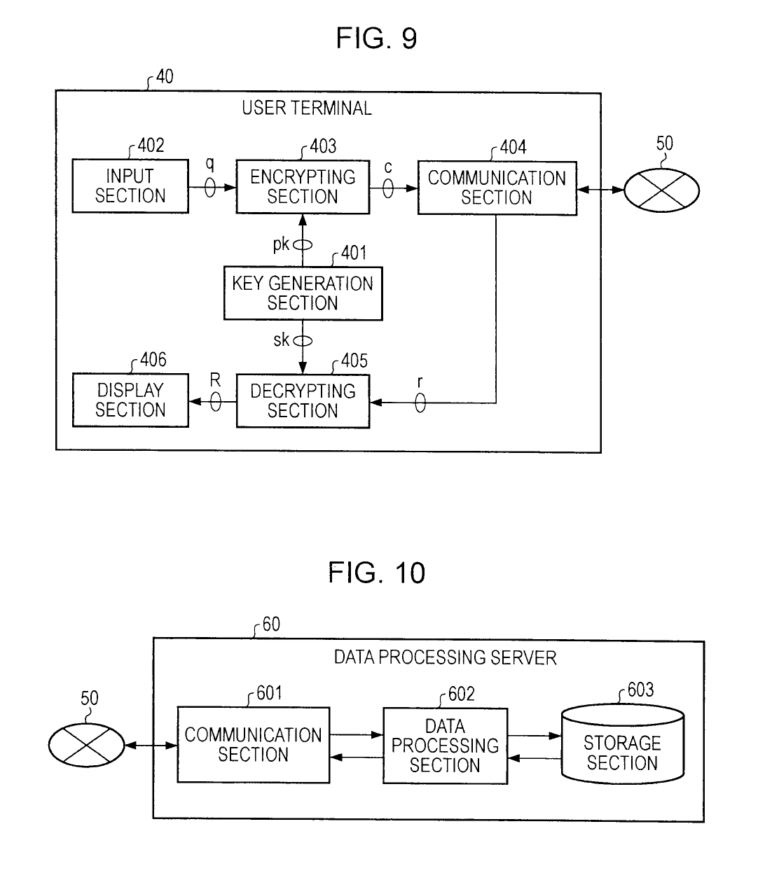

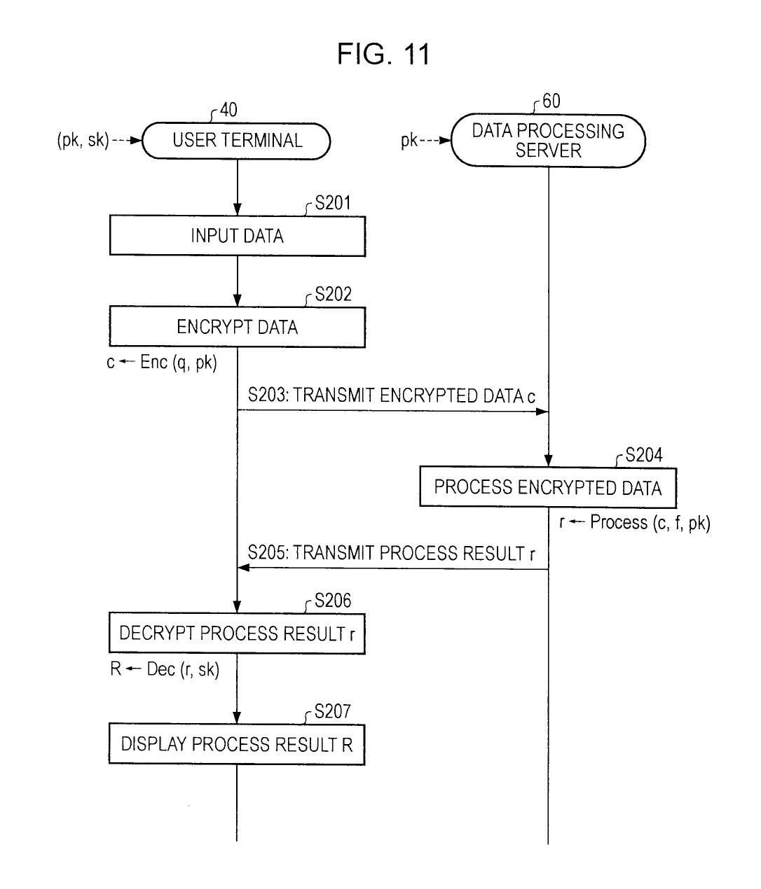

Then, referring to FIG. 8, a system configuration of a data processing system according to a second embodiment of the present disclosure will be described. Next, referring to FIG. 9, a functional configuration of a user terminal 40 according to the second embodiment will be described. Next, referring to FIG. 10, a functional configuration of a data processing server 60 according to the second embodiment will be described. Next, referring to FIG. 11, the flow of data processing in the data processing system according to the second embodiment will be described.

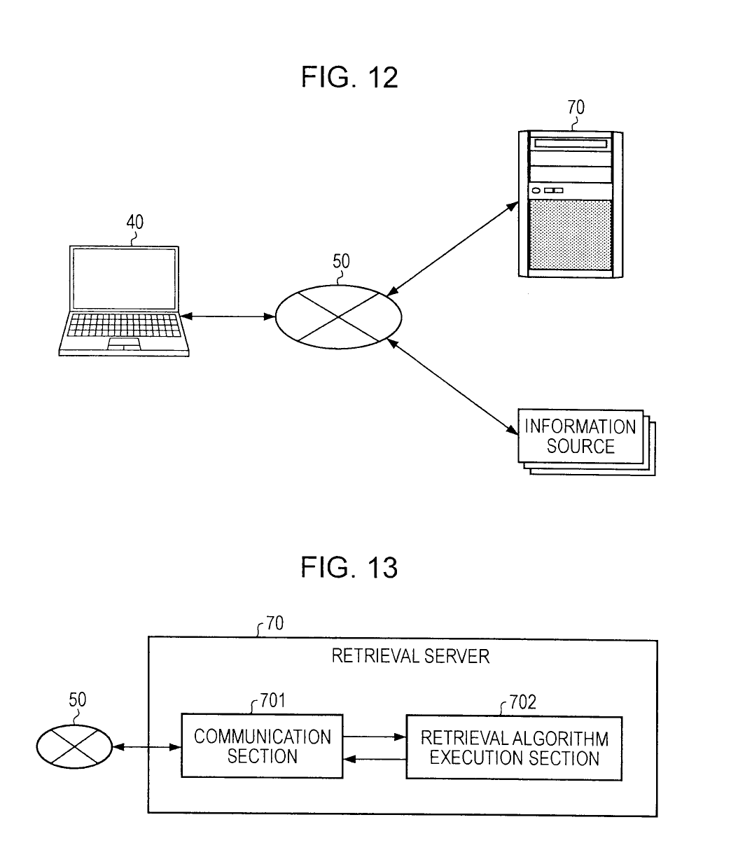

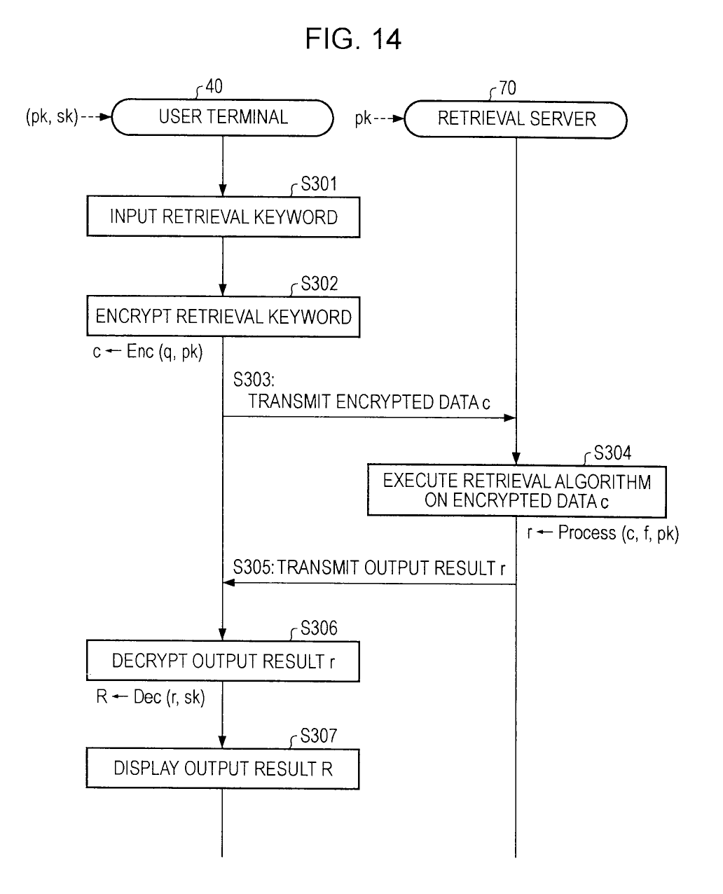

Then, referring to FIG. 12, a system configuration of a retrieval system according to a third embodiment of the present disclosure will be described. Next, referring to FIG. 13, a functional configuration of a retrieval server 70 according to the third embodiment will be described. Further, since the functional configuration of the user terminal 40 included in the retrieval system according to the third embodiment is substantially equal to the functional configuration of the user terminal 40 according to the second embodiment, the description of the functional configuration of the user terminal 40 will be omitted. Next, referring to FIG. 14, the flow of the retrieval process according to the third embodiment will be described.

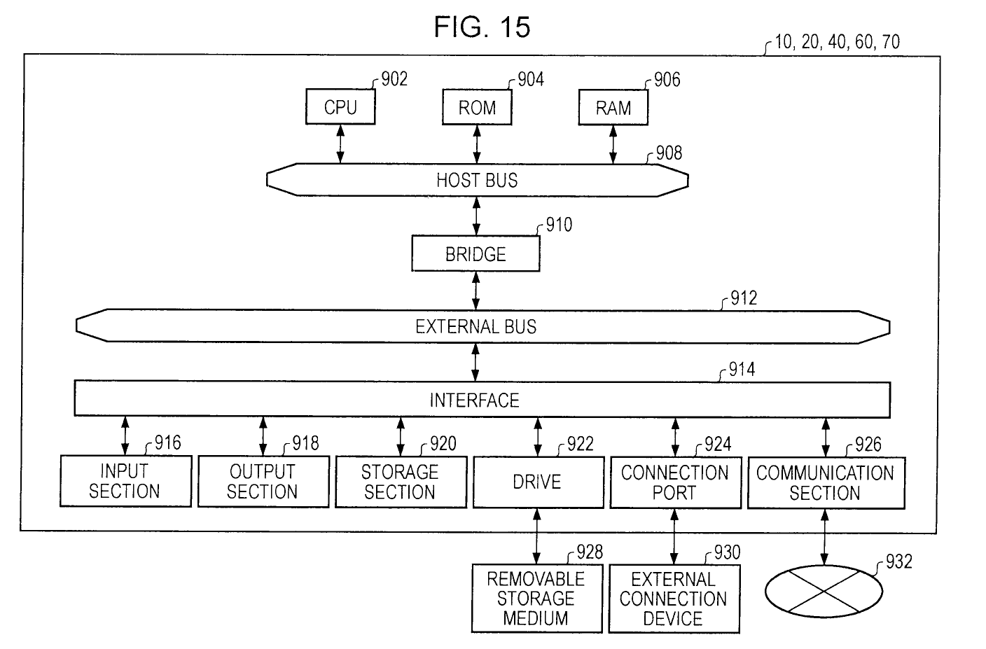

Then, referring to FIG. 15, an example of the hardware configurations for implementing the functions of the monitoring camera 10, the monitoring server 20, the user terminal 40, the data processing server 60, and the retrieval server 70 according to the embodiments of the present disclosure will be described. Finally, the technical ideas according to the embodiments of the present disclosure will be summed up, and operational advantages which can be obtained from the technical ideas will be described in brief.

Description Contents

### 1: First Embodiment

1-1: System Configuration of Monitoring Camera System

1-2: Functional Configuration of Monitoring Camera 10

1-3: Functional Configuration of Monitoring Server 20

1-3-1: Functional Configuration of Image Analysis section 21

1-3-2: Functional Configuration of Abnormality Determination Algorithm Generation section 22

1-4: Flow of Abnormality Determination Process

2: Second Embodiment

2-1: System Configuration of Data Processing System

2-2: Functional Configuration of User Terminal 40

2-3: Functional Configuration of Data Processing Server 60

2-4: Flow of Data Processing

3: Third Embodiment

3-1: System Configuration of Retrieval System

3-2: Functional Configuration of Retrieval Server 70

3-3: Flow of Retrieval Process

4: Hardware Configuration

5: Summary

### 1: First Embodiment

The first embodiment of the present disclosure will be described. The first embodiment relates to the monitoring camera system which is devised to not invade privacy unnecessarily.

### 1-1: System Configuration of Monitoring Camera System

First, referring to FIG. 1, the system configuration of the monitoring camera system according to the first embodiment will be described. FIG. 1 is a diagram illustrating the system configuration of the monitoring camera system according to the first embodiment.

As shown in FIG. 1, the monitoring camera system includes mainly the monitoring camera 10, the monitoring server 20, and a display 30. Further, in FIG. 1, the monitoring camera system is illustrated to have two monitoring cameras 10 (#1, #2), but the number of monitoring cameras 10 is not limited to two. For example, the technology of the embodiment may either be applied to the monitoring camera system having only one monitoring camera 10, or to the monitoring camera system having three or more monitoring cameras 10.

The monitoring camera 10 is an imaging device to capture a monitoring target. Further, the monitoring camera 10 is connected to the monitoring server 20. The monitoring camera 10 and the monitoring server 20 may be connected through a transmission cable, a network, or a radio communication network. However, in the following, the description will proceed assuming that the monitoring camera 10 and the monitoring server 20 are connected through the transmission cable.

When capturing a monitoring target, the monitoring camera 10 encrypts the captured image data. Then, the monitoring camera 10 transfers the encrypted data, which is obtained by encrypting the image data, to the monitoring server 20. If the image data is transferred to the monitoring server 20 without the encryption, even though there is no abnormality in the monitoring target, the image data obtained by capturing the monitoring target will be shown to an observer. In other words, the privacy of the monitoring target is invaded unnecessarily. In the configuration of the embodiment, when the image data is transferred to the monitoring server 20, the image data is encrypted. Of course, it is assumed that the encrypted data may not be decrypted by the monitoring server 20. In addition, the monitoring camera 10 encrypts the image data based on a fully homomorphic encryption scheme to be described later.

As described above, when the monitoring target is captured, the encrypted data is transferred from the monitoring camera 10 to the monitoring server 20. When the encrypted data is transferred, the monitoring server 20 performs a process of determining whether there is an abnormality in the monitoring target using the encrypted data. Specifically, the monitoring server 20 inputs the encrypted data, which is transferred from the monitoring camera 10, to an abnormality determination algorithm for the determination of the abnormality in the input image data. In this case, the abnormality determination algorithm is assumed to be included in the monitoring server 20 in advance. Then, when the abnormality determination algorithm outputs an operation result, the monitoring server 20 transfers the operation result output from the abnormality determination algorithm to the monitoring camera 10.

Further, since the fully homomorphic encryption scheme is used for encrypting the image data, the operation result output from the abnormality determination algorithm corresponds to an encrypted operation result which is obtained when the image data is input to the abnormality determination algorithm. When the operation result output from the abnormality determination algorithm is transferred from the monitoring server 20 to the monitoring camera 10, the monitoring camera 10 decrypts the operation result to obtain an operation result (hereinafter, referred to as an abnormality determination result) which is obtained when the image data is input to the abnormality determination algorithm. When the abnormality determination result is obtained, if there has been an abnormality in the monitoring target, the monitoring camera 10 transfers an unencrypted image data to the monitoring server 20 with reference to the abnormality determination result.

When the unencrypted image data is transferred to the monitoring server 20, the monitoring server 20 displays the image data onto the display 30. When the image data is displayed in the display 30, the observer checks the image data displayed onto the display 30 to visually determine whether there is an abnormality in the monitoring target. As described above, the abnormality determination algorithm remains maintained in the monitoring server 20. In addition, when there is no abnormality in the monitoring target, the image data of the monitoring target captured by the monitoring camera 10 is not transferred to the monitoring server 20. For this reason, when there is no abnormality in the monitoring target, the image data of the monitoring target is not shown to the observer, so that the unnecessary invasion of privacy can be avoided.

Fully Homomorphic Encryption Scheme

Here, the description of the fully homomorphic encryption scheme will be supplemented. The fully homomorphic encryption has the characteristics as shown in FIG. 6. Further, in the following, input data is denoted by “p”, a public key and a secret key of the fully homomorphic encryption scheme by “pk” and “sk” respectively, and a processing function of implementing a predetermined processing algorithm by “f”.

First, take note of the process designated by Process #1 of FIG. 6. Process #1 includes the three steps of the encrypting, the process A, and the decrypting. In the encrypting, the input data p is encrypted using the public key pk to generate the encrypted data c (c←Enc(p, pk)). In the subsequent process A, a predetermined process is implemented on the encrypted data c using the process function f and the public key pk, and obtains the process result r (r←Process(c, f, pk)). In the subsequent decrypting, the decrypting process is implemented on the process result r using the secret key sk, and the decrypting result R′ is generated (R′←Dec(r, sk)).

Next, take note of the process designated by Process #2 of FIG. 6. Process #2 includes the process B. In the process B, a predetermined process is implemented on the input data p using the process function f, and the process result R is obtained (R←Process(p, f)). As described above, Process #1 is the process in which the input data p is encrypted and then the process function f is implemented thereon, and Process #2 is the process in which the process function f is implemented while the input data p is not encrypted.

The characteristics of the fully homomorphic encryption consist in something that the results R and R′ obtained from these two processes are equivalent to each other. Further, for the detailed description of the fully homomorphic encryption scheme, refer to the documents, for example, “Fully Homomorphic Encryption Using Ideal Lattices” (Craig Gentry), and “Fully Homomorphic Encryption over the Integers” (Marten van Dijk, Craig Gentry, Shai Halevi, and Vinod Vaikuntanathian).

Using the characteristics of the fully homomorphic encryption, the process of the process function f on the input data p shown in Process #2 can be replaced with three steps such as those in the case of Process #1. In addition, in the case of Process #1, since the process A is implemented in a state where the input data p is encrypted, even if another person implements the process A, they are not able to know the contents of the input data p. In other words, by using the characteristics of the fully homomorphic encryption, the process on the input data p (the processing of the process function f) can be implemented by other people without letting them know the contents of the input data p.

As for the description of the correspondence with the monitoring camera system, the encrypting corresponds to a process of encrypting the image data in the monitoring camera 10. In addition, the process A corresponds to a process of the monitoring server 20 implementing the abnormality determination algorithm in which the encrypted data is input. The decrypting corresponds to a process in which the monitoring camera 10 obtains the abnormality determination result. In other words, with the characteristics of the fully homomorphic encryption, the abnormality determination process on the image data can be performed by the observer without letting the observer show the image data.

Hereinbefore, the system configuration of the monitoring camera system according to the embodiment has been described. In the following, the function of the respective components included in the monitoring camera system will be described in more detail.

### 1-2: Functional Configuration of Monitoring Camera 10

First, referring to FIG. 2, the functional configuration of the monitoring camera 10 according to the embodiment will be described. FIG. 2 is a diagram illustrating the functional configuration of the monitoring camera 10 according to the embodiment.

As shown in FIG. 2, the monitoring camera 10 includes mainly a key generation section 101, an imaging section 102, an image storage section 103, an encrypting section 104, a communication section 105, a decrypting section 106, and an image transmission section 107.

The key generation section 101 is a part which generates the public key pk and the secret key sk of the fully homomorphic encryption scheme. The public key pk generated by the key generation section 101 is input to the encrypting section 104. On the other hand, the secret key sk generated by the key generation section 101 is input to the decrypting section 106. The public key pk input to the encrypting section 104 is maintained by the encrypting section 104. In addition, the secret key sk input to the decrypting section 106 is maintained by the decrypting section 106. Further, the public key pk generated by the key generation section 101 is also supplied to the monitoring server 20. In addition, the public key pk supplied to the monitoring server 20 is maintained by the monitoring server 20.

The imaging section 102 is a part which captures the monitoring target to generate the image data p. The image data p generated by the imaging section 102 is sequentially stored in the image storage section 103. Then, the image data p stored in the image storage section 103 is read by the encrypting section 104. The encrypting section 104 having read the image data p encrypts the image data p using the public key pk to generate the encrypted data c (c←Enc(p, pk)). The encrypted data c generated by the encrypting section 104 is input to the communication section 105. When the encrypted data c is input, the communication section 105 transfers the input encrypted data c to the monitoring server 20.

When the encrypted data c is transferred to the monitoring server 20, the monitoring server 20 implements the process f based on the abnormality determination algorithm for the encrypted data c (r←Process(c, f, pk)), and then transfers the process result r to the monitoring camera 10. The process result r transferred from the monitoring server 20 is received by the communication section 105, and then input to the decrypting section 106. The decrypting section 106, having received the process result r, implements a decrypting process on the input process result r using the secret key sk to obtain the abnormality determination result R (R←Dec(r, sk)). The abnormality determination result R obtained by the decrypting process of the decrypting section 106 is input to the image transmission section 107.

When the abnormality determination result R is input, the image transmission section 107 determines whether the abnormality determination result R represents “Abnormality”, and if so, the image data p is read from the image storage section 103. When the abnormality determination result R represents “Abnormality”, the image transmission section 107 inputs the image data p read from the image storage section 103 to the communication section 105. When the image data p is input, the communication section 105 transfers the input image data p to the monitoring server 20. Further, when the abnormality determination result R represents “No Abnormality”, the image transmission section 107 does not read the image data p from the image storage section 103. For this reason, when there is no abnormality in the monitoring target, the image data p is not transferred to the monitoring server 20.

Hereinbefore, the functional configuration of the monitoring camera 10 has been described.

### 1-3: Functional Configuration of Monitoring Server 20

Next, referring to FIG. 3, the functional configuration of the monitoring server 20 according to the embodiment will be described. FIG. 3 is a diagram illustrating the functional configuration of the monitoring server 20 according to the embodiment.

As shown in FIG. 3, the monitoring server 20 includes mainly the image analysis section 21 and the abnormality determination algorithm generation section 22.

The image analysis section 21 is a part which analyzes the image data transferred from the monitoring camera 10 to detect the abnormality of the monitoring target included in the image data. In addition, the abnormality determination algorithm generation section 22 is the part which generates the abnormality determination algorithm for determining whether there is an abnormality in the monitoring target included in the image data. The abnormality determination algorithm generated by the abnormality determination algorithm generation section 22 is input to the image analysis section 21. Then, the image analysis section 21 analyzes the image data input from the monitoring camera 10, using the abnormality determination algorithm generated by the abnormality determination algorithm generation section 22.

However, in the embodiment, the image data is not transferred from the monitoring camera 10 to the monitoring server 20 until the monitoring target is determined to be abnormal. Alternatively, when the determination of whether there is an abnormality in the monitoring target is implemented, the encrypted data generated by encrypting the image data is input to the image analysis section 21. Then, the image analysis section 21 inputs the encrypted data to the abnormality determination algorithm, and transfers the determination result output from the abnormality determination algorithm to the monitoring camera 10. Further, the analysis process itself of the image analysis section 21 is substantially the same as the analysis process on the image data. The difference is the kind of data which is input to the abnormality determination algorithm.

On the other hand, when there is an abnormality in the monitoring target, the image data is transferred from the monitoring camera 10 to the monitoring server 20. In this case, the image analysis section 21 receives the image data which is transferred from the monitoring camera 10, and then displays the image data in the display 30. When the image data is displayed in the display 30, the observer refers to the image data displayed in the display 30 to visually determine whether there is an abnormality in the monitoring target. In addition, the image analysis section 21 maintains the image data which is transferred from the monitoring camera 10.

1-3-1: Functional Configuration of Image Analysis Section 21

Here, referring to FIG. 4, the functional configuration of the image analysis section 21 will be described in more detail. FIG. 4 is a diagram illustrating the functional configuration of the image analysis section 21 according to the embodiment.

As shown in FIG. 4, the image analysis section 21 includes a communication section 211, an abnormality determination algorithm execution section 212, an image reception section 213, and a storage section 214.

The communication section 211 is a part which receives the encrypted data or the image data from the monitoring camera 10, or transfers the determination result to the monitoring camera 10. In addition, the abnormality determination algorithm execution section 212 is the part which inputs the encrypted data to the abnormality determination algorithm generated by the abnormality determination algorithm generation section 22 and implements the process based on the abnormality determination algorithm. The process result based on the abnormality determination algorithm is transferred to the monitoring camera 10 via the communication section 211. The image reception section 213 is a part which receives the image data transferred from the monitoring camera 10 when it is determined that there is an abnormality in the monitoring target. The image reception section 213 having received the image data, stores the received image data in the storage section 214, and displays the image data in the display 30.

1-3-2: Functional Configuration of Abnormality Determination Algorithm Generation Section 22

Next, referring to FIG. 5, the functional configuration of the abnormality determination algorithm generation section 22 will be described in more detail. FIG. 5 is a diagram illustrating the functional configuration of the abnormality determination algorithm generation section 22 according to the embodiment.

As shown in FIG. 5, the abnormality determination algorithm generation section 22 includes mainly a learning data collection section 221, a storage section 222, and a machine learning section 223.

The learning data collection section 221 is a part which collects learning data used when the abnormality determination algorithm is generated. The learning data used for the generation of the abnormality determination algorithm includes, for example, the image data and determination result data which represents whether there is an abnormality in the monitoring target included in the image data. The learning data may either be collected from the monitoring camera 10 or from an information source (not shown), and alternatively be given by the observer in advance. The learning data collected by the learning data collection section 221 is stored in the storage section 222.

The learning data stored in the storage section 222 is read by the machine learning section 223. The machine learning section 223 having read the learning data uses the read learning data to generate the abnormality determination algorithm by machine learning. The abnormality determination algorithm generated by the machine learning section 223 is provided to the image analysis section 21.

Further, a machine learning method used by the machine learning section 223 is arbitrary. For example, the machine learning method, which is capable of generating a determiner for receiving the image data as an input and outputting whether there is an abnormality (for example, if there is no abnormality, outputting “0”; if there is an abnormality, outputting “1”), is conceivable. In addition, a machine learning method, which is capable of generating a determiner for receiving the image data as an input, combining a plurality of weak determiners which output “0” or “1”, and finally outputting whether there is an abnormality based on the results output from all the weak determiners, is conceivable. For example, the machine learning method, which generates a determiner for determining the abnormality when the number of the weak determiners outputting “1” exceeds a predetermined ratio, is conceivable.

As described above, the monitoring server 20 according to the embodiment has a function of inputting the encrypted data to the abnormality determination algorithm, which can determine the abnormality of the monitoring target from the image data, and of transferring the output to the monitoring camera 10. In addition, the monitoring server 20 has a function of maintaining the image data and of displaying the image data in the display 30 when the image data is transferred from the monitoring camera 10.

Further, in the example of FIG. 3, the configuration of the monitoring server 20 which generates the abnormality determination algorithm has been illustrated, but the abnormality determination algorithm may be provided from the outside to the monitoring server 20 in advance. In addition, the abnormality determination algorithm may be used which is generated by a method different from the machine learning. Furthermore, the abnormality determination algorithm generation section 22 may be configured to use the checking result of the image data, which is performed by the observer, in the generation process of the abnormality determination algorithm.

### 1-4: Flow of Abnormality Determination Process

Next, referring to FIG. 7, the flow of the abnormality determination process according to the embodiment will be described. FIG. 7 is a diagram illustrating the flow of the abnormality determination process according to the embodiment. Further, the abnormality determination process shown in FIG. 7 is implemented by the monitoring camera 10 and the monitoring server 20. In addition, the monitoring camera 10 is assumed to include the public key pk and the secret key sk of the fully homomorphic encryption scheme. Furthermore, the monitoring server 20 is assumed to include the public key pk of the fully homomorphic encryption scheme.

As shown in FIG. 7, first, the monitoring server 20 generates the abnormality determination algorithm f (S101). In addition, the monitoring camera 10 captures the monitoring target and generates the image data p (S102). The monitoring camera 10 having generated the image data p encrypts the image data p using the public key pk, and generates the encrypted data c (S103). In other words, the monitoring camera 10 implements c←Enc(p, pk). Next, the monitoring camera 10 transfers the encrypted data c to the monitoring server 20 (S104).

The monitoring server 20 having received the encrypted data c inputs the received encrypted data c to the abnormality determination algorithm f, and implements the abnormality determination algorithm f using the public key pk (S105). In other words, the monitoring server 20 implements r←Process(c, f, pk), and obtains the output result r of the abnormality determination algorithm f. Next, the monitoring server 20 transmits the output result r of the abnormality determination algorithm f to the monitoring camera 10 (S106).

The monitoring camera 10, which has received the output result r of the abnormality determination algorithm f, implements the decrypting process on the output result r of the abnormality determination algorithm f using the secret key sk to obtain the abnormality determination result R (S107). In other words, the monitoring camera 10 implements R←Dec(r, sk). The monitoring camera 10 that has obtained the abnormality determination result R determines whether the abnormality determination result R represents “Abnormality”, and if so, the procedure proceeds to step S109. On the other hand, when the abnormality determination result R represents “No Abnormality”, the monitoring camera 10 causes the procedure to proceed to step S102.

When the procedure proceeds to step 5109, the monitoring camera 10 transmits the image data p generated in step 5102 to the monitoring server 20 (S109). The monitoring server 20 that has received the image data p displays the received image data p in the display 30 (S110). At this time, the monitoring server 20 maintains the image data p received from the monitoring camera 10. When the image data p is displayed in the display 30, the observer refers to the image data p displayed in the display 30 to visually determine whether there is an abnormality in the monitoring target.

Hereinbefore, the flow of the abnormality determination process according to the embodiment has been described. Further, in transmitting the image data p in step S109, an encryption key for communication may be used to encrypt the image data p. The encryption key for communication may either be an encryption key in a public key encryption scheme, or an encryption key in a common key encryption scheme. In addition, in the example of FIG. 7, the abnormality determination algorithm f is described to be generated in step S101, but the abnormality determination algorithm f may be provided from the outside to the monitoring server 20 in advance.

Hereinbefore, the first embodiment of the present disclosure has been described. By applying the technology according to the embodiment, the abnormality determination algorithm may not necessarily be loaded on the monitoring camera 10, and it is not necessary to transmit the image data having no abnormality to the monitoring server 20. As a result, the risk of revealing the abnormality determination algorithm is avoided, and the unnecessary invasion of privacy can be prevented. In addition, even when the abnormality determination algorithm is updated, it is sufficient to update the abnormality determination algorithm in the monitoring server 20, so that the cost for updating the algorithm can be suppressed to a low level. In other words, the observer does not have to go to the trouble of visually checking the image data of the monitoring target having no abnormality, and the labor cost in monitoring can be suppressed to a low level.

### 2: Second Embodiment

Next, the second embodiment of the present disclosure will be described. The second embodiment relates to a data processing system in which the server performs the data processing. For example, the technology according to the embodiment may be applied to a cloud system, a thin client system, and the like.

### 2-1: System Configuration of Data Processing System

First, referring to FIG. 8, the system configuration of the data processing system according to the embodiment will be described. FIG. 8 is a diagram illustrating the system configuration of the data processing system according to the embodiment.

As shown in FIG. 8, the data processing system according to the embodiment includes mainly a user terminal 40 and a data processing server 60. In addition, the user terminal 40 and the data processing server 60 are assumed to be connected to each other via a network 50. Further, in FIG. 8, the configuration of the data processing system having two data processing servers 60 (#1, #2) is illustrated as an example, but the number of the data processing servers 60 is not limited to two. For example, the technology of the embodiment may either be applied to the data processing system having only one data processing server 60, or to the data processing system having three or more data processing servers 60.

The user terminal 40 is a part through which a user inputs data, or which displays the data. For example, the user terminal 40 displays the execution screen of the application such as a web browser, a word processor, spreadsheet software, or image editing software, or receives a data input for the application. Further, display data for displaying the execution screen of the application may be provided from the data processing server 60 to the user terminal 40, or may be generated by the user terminal 40.

The data processing server 60 is a part which processes data transmitted from the user terminal 40. In receiving the data to be processed from the user terminal 40, the data processing server 60 implements a predetermined process on the received data, and transmits the processed data to the user terminal 40. As an example of the predetermined process, a letter type conversion process, a keyword retrieval process, a calculation process using various functions, an information retrieval process for targeting an information source connected to the network 50, various image processes, and processes related to various kinds of applications are exemplified.

However, the embodiment is to provide a mechanism in which the data processing server 60 implements the data processing, while the processing data is not informed to the data processing server 60. In other words, the embodiment is to provide the configuration in which the contents of the processing data input to the user terminal 40 is not revealed to the data processing server 60, so as not to invade user privacy. For the purpose of realizing the above configuration, in order not to transmit the processing data as it is to the data processing server 60, the user terminal 40 encrypts the processing data in the fully homomorphic encryption scheme, and transmits the encrypted data (hereinafter, referred to as encrypted data) to the data processing server 60.

In addition, the data processing server 60 having received the encrypted data implements a predetermined process on the received encrypted data, and transmits the data obtained after the process (hereinafter, referred to as processed data) to the user terminal 40. Then, the user terminal 40 that has received the processed data decrypts the processed data which has been received. As described above, with the characteristics of the fully homomorphic encryption, the data obtained by the decrypting process of the user terminal 40 becomes the same as the data obtained by implementing a predetermined process on the original data to be processed. In other words, the user terminal 40 makes the data processing server 60 process the processing data.

As described above, by encrypting the processing data in the fully homomorphic encryption scheme, and by making the data processing server 60 process the encrypted data, the contents of the processing data may not necessarily be known to the data processing server 60. As a result, the unnecessary invasion of user privacy can be avoided. For example, an electronic mail application or the document contents input by the user in a word processor does not become known to the data processing server 60, and an invasion of user privacy is prevented.

Hereinbefore, the system configuration of the data processing system according to the embodiment has been described. In the following, the functions of the respective components which are included in the data processing system will be described in more detail.

### 2-2: Functional Configuration of User Terminal 40

First, referring to FIG. 9, the functional configuration of the user terminal 40 according to the embodiment will be described. FIG. 9 is a diagram illustrating the functional configuration of the user terminal 40 according to the embodiment.

As shown in FIG. 9, the user terminal 40 includes mainly a key generation section 401, an input section 402, an encrypting section 403, a communication section 404, a decrypting section 405, and a display section 406.

The key generation section 401 is a part which generates the public key pk and the secret key sk of the fully homomorphic encryption scheme. The public key pk generated by the key generation section 401 is input to the encrypting section 403. On the other hand, the secret key sk generated by the key generation section 401 is input to the decrypting section 405. The public key pk input to the encrypting section 403 is maintained by the encrypting section 403. In addition, the secret key sk input to the decrypting section 405 is maintained by the decrypting section 405. Further, the public key pk generated by the key generation section 401 is also provided to the data processing server 60. In addition, the public key pk provided to the data processing server 60 is maintained by the data processing server 60.

The input section 402 is an input part which is used to input the processing data (hereinafter, referred to as the input data q). The input data q, which is input by using the input section 402, is sequentially input to the encrypting section 403. When the input data q is input, the encrypting section 403 encrypts the input data q using the public key pk, and generates the encrypted data c (c←Enc(q, pk)). The encrypted data c generated by the encrypting section 403 is input to the communication section 404. When the encrypted data c is input, the communication section 404 transmits the input encrypted data c to the data processing server 60.

The data processing server 60 having received the encrypted data c implements a predetermined process f on the encrypted data c (r←Process(c, f, pk)), and transmits the process result r to the user terminal 40. The process result r transmitted from the data processing server 60 is received by the communication section 404, and input to the decrypting section 405. The decrypting section 405 having received the process result r implements the decrypting process on the received process result r using the secret key sk, and obtains the process result R (hereinafter, referred to as a decrypted process result R) with respect to the input data q (R←Dec(r, sk)). The decrypted process result R obtained in the decrypting process of the decrypting section 405 is input to the display section 406. The display section 406 having received the decrypted process result R displays the decrypted process result R which has been received.

Hereinbefore, the functional configuration of the user terminal 40 has been described.

### 2-3: Functional Configuration of Data Processing Server

Next, referring to FIG. 10, the functional configuration of the data processing server 60 according to the embodiment will be described. FIG. 10 is a diagram illustrating the functional configuration of the data processing server 60 according to the embodiment.

As shown in FIG. 10, the data processing server 60 includes mainly a communication section 601, a data processing section 602, and a storage section 603.

The communication section 601 is a communication part which receives data from the user terminal 40 via the network 50, and transmits the data to the user terminal 40. When the encrypted data is transmitted from the user terminal 40, the communication section 601 receives the encrypted data. The encrypted data received by the communication section 601 is input to the data processing section 602. When the encrypted data is input, the data processing section 602 implements a predetermined process on the input encrypted data. The processed data obtained by the data processing section 602 is input to the communication section 601. When the processed data is input, the communication section 601 transmits the input processed data to the user terminal 40. Further, the data processing section 602 appropriately stores the input encrypted data and the processed data in the storage section 603.

Hereinbefore, the functional configuration of the data processing server 60 according to the embodiment has been described.

As described above, in the embodiment, the processing data is not transmitted without any change to the data processing server 60. For this reason, by applying the mechanism of the data processing system according to the embodiment, the content of the data input to the user terminal 40 may not necessarily be known to the data processing server 60, and the user privacy can be protected.

### 2-4: Flow of Data Processing

Next, referring to FIG. 11, the flow of the data processing according to the embodiment will be described. FIG. 11 is a diagram illustrating the flow of the data processing according to the embodiment. Further, the data processing shown in FIG. 11 is performed by the user terminal 40 and the data processing server 60. In addition, the user terminal 40 is assumed to include the public key pk and the secret key sk of the fully homomorphic encryption scheme. Furthermore, the data processing server 60 is assumed to include the public key pk of the fully homomorphic encryption scheme.

As shown in FIG. 11, first, the processing data (hereinafter, referred to as the input data q) is input to the user terminal 40 (S201). When the input data q is input, the user terminal 40 encrypts the input data q using the public key pk, and generates the encrypted data c (S202). In other words, the user terminal 40 implements c←Enc(q, pk). Next, the user terminal 40 transmits the encrypted data c to the data processing server 60 (S203).

The data processing server 60, which has received the encrypted data c, inputs the received encrypted data c to a predetermined process algorithm f, and implements the process algorithm f using the public key pk (S204). In other words, the data processing server 60 implements r←Process(c, f, pk), and obtains the process result r through the process algorithm f. Next, the data processing server 60 transmits the process result r to the user terminal 40 (S205).

The user terminal 40, which has received the process result r, implements the decrypting process on the process result r using the secret key sk, and obtains the decrypted process result R (S206). In other words, the user terminal 40 implements R←Dec(r, sk). When the decrypted process result R is obtained, the user terminal 40 displays the decrypted process result R for the user (S207).

Hereinbefore, the flow of the data processing according to the embodiment has been described.

Hereinbefore, the second embodiment of the present disclosure has been described. By applying the technology according to the embodiment, the processing data is not known to the data processing server 60, and the process thereof can be performed by the data processing server 60. As a result, the content of the data input by the user may not necessarily be known to the data processing server 60, and the user privacy is protected.

For example, in a system which collects information from a plurality of terminals placed respectively in a plurality of stores, sums up and processes the information, there is a situation in which each store wishes to share the information but does not want to let the other stores gain unique information relating to its own store. In this case, by applying the technology of the embodiment, the information of the respective stores is encrypted for protection, and on the other hand, each piece of information can be processed as in the case when no encrypting is implemented. In addition, the technology of the embodiment can be applied even in a case when medical institutions share information. For example, without letting the other medical institutions know the patient information, the medical information can be shared. In other words, while protecting patient privacy, a plurality of medical institutions can share the information.

### 3: Third Embodiment

Next, the third embodiment of the present disclosure will be described. The embodiment relates to a retrieval system for retrieving information which is contained in an information source connected to the network 50. Further, the retrieval system according to the embodiment is an example of the application of the data processing system according to the second embodiment. For this reason, the description already given to the components having substantially the same functions as those of the second embodiment will be omitted, and the same reference numerals are designated to omit detailed description.

### 3-1: System Configuration of Retrieval System

First, referring to FIG. 12, the system configuration of the retrieval system according to the embodiment will be described. FIG. 12 is a diagram illustrating the system configuration of the retrieval system according to the embodiment.

As shown in FIG. 12, the retrieval system according to the embodiment includes mainly the user terminal 40 and the retrieval server 70. In addition, the user terminal 40 and the retrieval server 70 are connected to each other via the network 50. Further, in FIG. 12, the configuration of the retrieval system having one retrieval server 70 is illustrated as an example, but the number of retrieval servers 70 is not limited to one. For example, the technology of the embodiment can be applied even to the data processing system having two or more retrieval servers 70 for load distribution.

The user terminal 40 has substantially the same functions as those of the user terminal 40 according to the second embodiment. However, the description will be made by specifically focusing on the retrieval process. The user terminal 40 includes the function of performing the application such as a web browser. In addition, the user terminal 40 includes the function of receiving a retrieval keyword as an input through the application. When the retrieval keyword is input to the user terminal 40, the user terminal 40 transmits the input retrieval keyword to the retrieval server 70.

The retrieval server 70 is a part which retrieves information including the retrieval keyword, which is transmitted from the user terminal 40, from the information source connected to the network 50. When the retrieval keyword is received from the user terminal 40, the retrieval server 70 accesses the information source connected to the network 50, and retrieves the information having the received retrieval keyword. As an information source, for example, a homepage, a blog, and a message board which are opened to the public on the web may be considered. Of course, in addition to these, a database in which information is accumulated may be considered as the information source. In addition, the information source is assumed to be connected to the network 50, but the database stored in a storage device (not shown) connected to the retrieval server 70 may be used as the information source.

The embodiment is to make the retrieval process implemented based on the retrieval keyword while not letting the retrieval server 70 know the retrieval keyword. For this purpose, in the embodiment, the user terminal 40 does not transmit the retrieval keyword as it is to the retrieval server 70, but encrypts the retrieval keyword in the fully homomorphic encryption scheme and then transmits it to the retrieval server 70. On the other hand, the retrieval server 70 having received the encrypted retrieval keyword implements the retrieval process using the encrypted retrieval keyword, and transmits the retrieval result to the user terminal 40. Then, the user terminal 40 having received the retrieval result decrypts the received retrieval result, and obtains the original form of information which has been provided from the information source.

As described above, the retrieval keyword is encrypted in the fully homomorphic encryption scheme, and the retrieval server 70 implements the retrieval process based on the encrypted retrieval keyword, thereby not letting the retrieval server 70 know the retrieval keyword. As a result, the unnecessary invasion of user privacy can be prevented.

Hereinbefore, the system configuration of the retrieval system according to the embodiment has been described. Next, the functions of the respective components included in the retrieval system will be described in more detail. However, since the functional configuration of the user terminal 40 is substantially equal to that of the user terminal 40 according to the second embodiment, the description thereof will be omitted.

### 3-2: Functional Configuration of Retrieval Server 70

Referring to FIG. 13, the functional configuration of the retrieval server 70 according to the embodiment will be described. FIG. 13 is a diagram illustrating the functional configuration of the retrieval server 70 according to the embodiment.

As shown in FIG. 13, the retrieval server 70 includes mainly a communication section 701 and a retrieval algorithm execution section 702.

The communication section 701 is a communication part which receives data via the network 50 from the user terminal 40, and transmits the data to the user terminal 40. When the encrypted retrieval keyword is transmitted from the user terminal 40, the communication section 701 receives the encrypted retrieval keyword (hereinafter, referred to as the encrypted data). The encrypted data received by the communication section 701 is input to the retrieval algorithm execution section 702.

When the encrypted data is input, the retrieval algorithm execution section 702 implements the retrieval algorithm in which the encrypted data is input. When the retrieval result is output from the retrieval algorithm, the retrieval algorithm execution section 702 inputs the retrieval result (hereinafter, referred to as an output result) output from the retrieval algorithm to the communication section 701. The communication section 701, which has received the output result, transmits the received output result to the user terminal 40.

Hereinbefore, the functional configuration of the retrieval server 70 according to the embodiment has been described.

As described above, in the embodiment, the retrieval keyword is not transmitted as it is to the retrieval server 70. For this reason, by applying the mechanism of the retrieval system according to the embodiment, the content of the retrieval keyword input to the user terminal 40 may not necessarily be known to the retrieval server 70, and the user privacy can be protected.

### 3-3: Flow of Retrieval Processing

Next, referring to FIG. 14, the flow of the retrieval process according to the embodiment will be described. FIG. 14 is a diagram illustrating the flow of the retrieval process according to the embodiment. Further, the retrieval process shown in FIG. 14 is implemented by the user terminal 40 and the retrieval server 70. In addition, the user terminal 40, is assumed to include the public key pk and the secret key sk of the fully homomorphic encryption scheme. Furthermore, the retrieval server 70 is assumed to include the public key pk of the fully homomorphic encryption scheme.

As shown in FIG. 14, first, the user terminal 40 receives a retrieval keyword q (S301). When the retrieval keyword q is received, the user terminal 40 encrypts the retrieval keyword q using the public key pk, and generates the encrypted data c (S302). In other words, the user terminal 40 implements c-Enc(q, pk). Next, the user terminal 40 transmits the encrypted data c to the retrieval server 70 (S303).

The retrieval server 70, which has received the encrypted data c, inputs the received encrypted data c to the retrieval algorithm f, and implements the process by the retrieval algorithm f using the public key pk (S304). In other words, the retrieval server 70 implements r←Process(c, f, pk), and obtains the retrieval result r (hereinafter, referred to as the output result r) output from the retrieval algorithm f. Next, the retrieval server 70 transmits the output result r to the user terminal 40 (S305).

The user terminal 40, which has received the output result r, implements the decrypting process on the output result r using the secret key sk, and obtains the output result R (which corresponds to the retrieval result by the retrieval keyword q) (S306). In other words, the user terminal 40 implements R←Dec(r, sk). When the output result R is obtained, the user terminal 40 displays the output result R for the user (S307).

Hereinbefore, the flow of the retrieval process according to the embodiment has been described.

Hereinbefore, the third embodiment of the present disclosure has been described. By applying the technology according to the embodiment, the retrieval process can be implemented without letting the retrieval server 70 know the retrieval keyword. As a result, the content of the retrieval keyword input by the user may not necessarily be known to the retrieval server 70, and user privacy can be protected.

### 4: Hardware Configuration

The functions of the respective components included in the monitoring camera 10, the monitoring server 20, the user terminal 40, the data processing server 60, and the retrieval server 70 may be implemented using, for example, the hardware configuration of an information processing device shown in FIG. 15. In other words, the functions of the respective components are realized by controlling the hardware shown in FIG. 15 using computer programs. Further, the form of the hardware is arbitrary, and for example, a portable information terminal such as a personal computer, a portable telephone, a PHS, and a PDA, a game machine, or various information appliances are included. Herein, the PHS is the abbreviation of “Personal Handy-phone System”. In addition, the PDA is the abbreviation of “Personal Digital Assistant”.

As shown in FIG. 15, the hardware includes mainly a CPU 902, a ROM 904, a RAM 906, a host bus 908, and a bridge 910. Further, the hardware includes an external bus 912, an interface 914, an input section 916, an output section 918, a storage section 920, a drive 922, a connection port 924, and a communication section 926. Herein, the CPU is the abbreviation of “Central Processing Unit”. In addition, the ROM is the an abbreviation of “Read Only Memory”. Further, the RAM is the abbreviation of “Random Access Memory”.

The CPU 902, for example, serves as an arithmetic processing unit or a control unit, and controls all or a part of the operations of the respective components based on various programs stored in the ROM 904, the RAM 906, the storage section 920, or a removable storage medium 928. The ROM 904 is a part which stores the programs read by CPU 902 or data used for an arithmetical process. In the RAM 906, for example, the programs read by the CPU 902 or various parameters which vary as appropriate according to the execution of the programs are stored temporarily or permanently.

These components, for example, are connected to each other via the host bus 908 which is capable of transmitting data at a high rate. On the other hand, the host bus 908 is connected, for example, via the bridge 910 to the external bus 912 of which data transmission rate is relatively low. In addition, as the input section 916, for example, a mouse, a keyboard, a touch panel, buttons, switches, and levers may be used. Furthermore, as the input section 916, a remote controller may be used which can transmit a control signal using infrared or other radio waves.

As the output section 918, devices which can inform acquired information visually and auditorily to the user, for example, a display device such as a CRT, an LCD, a PDP, or an ELD; an audio output device such as a speaker and a headphone; a printer; a portable telephone; or a facsimile are exemplified. Herein, the CRT is the abbreviation of “Cathode Ray Tube”. In addition, the LCD is the abbreviation of “Liquid Crystal Display”. Then, the PDP is the abbreviation of “Plasma Display Panel”. Furthermore, the ELD is the abbreviation of “Electro-Luminescence Display”.

The storage section 920 is a device for storing various types of data. As the storage section 920, for example, a magnetic-storage device such as an HDD, a semiconductor memory device, an optical memory device, or a magneto-optical memory device may be used. Herein, the above HDD is the abbreviation of “Hard Disk Drive”.

The drive 922 is a device which reads out information recorded in the removable storage medium 928 such as a magnetic disc, an optical disc, a magnetic-optical disc, or a semiconductor memory, or writes the information to the removable storage medium 928. The removable storage medium 928 may include, for example, DVD media, Blu-ray media, HD DVD media, and various kinds of semiconductor media. Of course, the removable storage medium 928 may be, for example, an IC card on which a contactless IC chip is mounted, or an electronic device. Herein, the IC is the abbreviation of “Integrated Circuit”.

The connection port 924 is a port for connecting an external connection device 930 such as a USB port, an IEEE1394 port, a SCSI, an RS-232C port, and an optical audio terminal. The external connection device 930 may be, for example, a printer, a portable music player, a digital camera, a digital video camera, an IC recorder, or the like. Herein, the USB is the abbreviation of “Universal Serial Bus”. In addition, the SCSI is the abbreviation of “Small Computer System Interface”.

The communication section 926 is a communication device for the connection to the network 932, and a wired or wireless LAN, Bluetooth (Registered Trademark), or a communication card for a WUBS, a router for an optical communication, a router for an ADSL, and various MODEMs for communication are exemplified. In addition, the network 932, which is connected to the communication section 926, includes a wired or wireless connection network, for example, the Internet, a home LAN, infrared communication, visible light communication, broadcasts, satellite communication, and the like. Herein, the LAN is the abbreviation of “Local Area Network”. In addition, the WUSB is the abbreviation of “Wireless USB”. Then, the ADSL is the abbreviation of “Asymmetric Digital Subscriber Line”.

### 5: Summary

Finally, the technology content according to the embodiments of the present disclosure will be summed up briefly.

The technology according to the above-mentioned embodiments relates to the data processing system which includes the terminal device and the server as follows. The terminal device includes the encrypting section, the encrypted data transmission section, the encrypted data reception section, and the decrypting section. The encrypting section encrypts the input data in the fully homomorphic encryption scheme to generate the encrypted data. In addition, the encrypted data transmission section transmits the encrypted data generated by the encrypting section to the server. Then, the encrypted data reception section receives the encrypted data on which a predetermined process is implemented by the server. Furthermore, the decrypting section decrypts the encrypted data on which the predetermined process is implemented.

By employing the fully homomorphic encryption scheme as an encryption scheme, the decrypting result of data obtained by implementing a predetermined process on the encrypted data is equal to that of data obtained by implementing a predetermined process on input data. For this reason, even though the encrypted data is processed in the server, the terminal device can obtain substantially the same processing result as in the case when the input data is processed in the server. Furthermore, since the contents of the input data is not revealed to the server at all, the terminal device can make the server perform the process of the input data without letting the server know the contents of the input data.

### Remarks

The monitoring camera 10 and the user terminal 40 are examples of the terminal device. The communication sections 105 and 404 are examples of the encrypted data transmission section, the encrypted data reception section, a first transmission section, and a first reception section. The image transmission section 107 is an example of the abnormality determination section and the image data transmission section. The encrypting sections 104, 403 and the decrypting sections 106, 405 are examples of the key holding section. The monitoring server 20, the data processing server 60, and the retrieval server 70 are examples of the server. The communication sections 211, 601, and 701 are examples of the encrypted data reception section, the encrypted data transmission section, a second reception section, and a second transmission section. The abnormality determination algorithm execution section 212, the data processing section 602, and the retrieval algorithm execution section 702 are examples of the process section. The monitoring camera system and the retrieval system are examples of the data processing system.

The present disclosure contains subject matter related to that disclosed in Japanese Priority Patent Application JP 2010-188128 filed in the Japan Patent Office on Aug. 25, 2010, the entire contents of which are hereby incorporated by reference.

It should be understood by those skilled in the art that various modifications, combinations, sub-combinations and alterations may occur depending on design requirements and other factors insofar as they are within the scope of the appended claims or the equivalents thereof.

What is claimed is:

1. A terminal device comprising:
an encrypting section encrypting input data in a fully homomorphic encryption scheme to generate encrypted data;
an encrypted data transmission section transmitting the encrypted data generated by the encrypting section to a server;
an encrypted data reception section receiving the encrypted data on which the server implements a predetermined process; and
a decrypting section decrypting the encrypted data on which the predetermined process is implemented.

2. The terminal device according to claim 1, further comprising an imaging section capturing a subject to generate image data,
wherein the encrypting section encrypts the image data generated by the imaging section to generate encrypted data, and
wherein the predetermined process is a process in which the encrypted data is input to an abnormality determination algorithm for determining an abnormality in the subject based on the image data and a determination result output from the abnormality determination algorithm is output as encrypted data on which the predetermined process is implemented.

3. The terminal device according to claim 2, further comprising:
an abnormality determination section determining whether there is an abnormality in the determination result after the encrypted data on which the decrypting section implements the predetermined process is decrypted and the determination result is output from the abnormality determination algorithm; and
an image data transmission section transmitting the image data generated by the imaging section to the server when there is an abnormality in the determination result of the abnormality determination section.

4. The terminal device according to claim 3, further comprising a key holding section holding a public key and a secret key based on the fully homomorphic encryption scheme,
wherein the encrypting section encrypts input data using the public key which is held by the key holding section, and
wherein the decrypting section decrypts the encrypted data on which the predetermined process is implemented, using the secret key which is held by the key holding section.

5. The terminal device according to claim 4, wherein the predetermined process is implemented using the public key.

6. The terminal device according to claim 1, further comprising:
an input section inputting retrieval data; and
a display section displaying a retrieval result based on the retrieval data,
wherein the encrypting section encrypts the retrieval data, which is input by the input section, to generate encrypted data,
wherein the predetermined process is a process in which the encrypted data is input to a retrieval algorithm for retrieving information based on the retrieval data and outputs the retrieval result output from the retrieval algorithm as the encrypted data on which the predetermined process is implemented, and
wherein after the encrypted data on which the predetermined process is implemented is decrypted by the decrypting section and the retrieval result output from the retrieval algorithm is obtained, the display section displays the retrieval algorithm.

7. A server comprising:
an encrypted data reception section receiving encrypted data from a terminal device, the encrypted data being obtained by encrypting input data in a fully homomorphic encryption scheme;
a process section implementing a predetermined process on the encrypted data; and
an encrypted data transmission section transmitting the encrypted data to the terminal device, the predetermined process being implemented on the encrypted data.

8. A data processing system comprising:
a terminal device which includes
an encrypting section encrypting input data in a fully homomorphic encryption scheme to generate encrypted data,
a first transmission section transmitting the encrypted data to a server, the encrypted data being generated by the encrypting section,
a first reception section receiving the encrypted data on which the server implements a predetermined process, and
a decrypting section decrypting the encrypted data on which the predetermined process is implemented; and
a server which includes
a second reception section receiving the encrypted data transmitted from the first transmission section,
a process section implementing the predetermined process on the encrypted data, and
a second transmission section transmitting the encrypted data to the terminal device, the predetermined process being implemented on the encrypted data.

9. A data processing method comprising:
causing a terminal device
to encrypt input data in a fully homomorphic encryption scheme to generate encrypted data, and
to transmit the encrypted data to a server, the encrypted data being generated in the encrypting of the input data;
causing the server
to receive the encrypted data which is transmitted in the transmitting of the encrypted data to the server,
to implement a predetermined process on the encrypted data, and
to transmit the encrypted data to the terminal device, the predetermined process being implemented on the encrypted data; and
causing the terminal device
to receive the encrypted data on which the server implements the predetermined process, and
to decrypt the encrypted data on which the predetermined process is implemented.

10. A program causing a computer to execute:
an encrypting function of encrypting input data in a fully homomorphic encryption scheme to generate encrypted data;
an encrypted data transmission function of transmitting the encrypted data generated by the encrypting function to a server;
an encrypted data reception function of receiving the encrypted data on which the server implements a predetermined process; and
a decrypting function of decrypting the encrypted data on which the predetermined process is implemented.

11. A program causing a computer to execute:
an encrypted data reception function of receiving encrypted data from a terminal device, the encrypted data being obtained by encrypting input data in a fully homomorphic encryption scheme;
a process function of implementing a predetermined process on the encrypted data; and
an encrypted data transmission function of transmitting the encrypted data to the terminal device, the predetermined process being implemented on the encrypted data.
